(19) United States
(12) Patent Application Publication
(10) Pub. No.: US 2012/0257229 A1
(43) Pub. Date: Oct. 11, 2012

(54) IMAGE READING APPARATUS, IMAGE READING APPARATUS CONTROL METHOD, AND STORAGE MEDIUM

(75) Inventor: Takao Ikuno, Yokohama-shi (JP)

(73) Assignee: CANON KABUSHIKI KAISHA, Tokyo (JP)

(21) Appl. No.: 13/421,011

(22) Filed: Mar. 15, 2012

(30) Foreign Application Priority Data
Apr. 5, 2011 (JP) 2011-083689

(51) Int. Cl. G06K 15/02; H04N 1/04

(52) U.S. Cl. 358/1.12; 358/498

(57) ABSTRACT

An image reading apparatus includes a reading unit to read an original document first side, reverse the original document, and read an image on a second side of the original document and includes a control unit. The control unit controls the reading by either a first or second reading method. In the first reading method, after reading a first side of an original document, the reading unit reads a second side of the original document, and in the second reading method, after reading a first side of a first original document and a first side of a subsequent second original document, the reading unit reads a second side of the first original document. In a case where a plurality of original documents are conveyed, reading includes reading the first original document by the first reading method and reading the second and the subsequent original documents by the second reading method.

### BACKGROUND OF THE INVENTION

1. Field of the Invention

The present invention relates to an image reading apparatus, a control method of the image reading apparatus, and a storage medium.

2. Description of the Related Art

Image reading apparatuses, such as copying machines and multifunction peripherals, include a reading unit to read original documents. In addition, these image reading apparatuses execute image processing on the read image data to print or transmit the processed image data. Such reading unit of the image reading apparatus often functions in conjunction with an automatic original document feeding apparatus which automatically conveys a stack of original documents one by one to the reading unit.

In the case of an apparatus without the automatic original document feeding apparatus, since a user needs to place original documents one by one to be read by the reading unit, a great amount of time and effort is required. Thus, for users, these automatic original document feeding apparatuses are very useful in improving productivity.

Some of the automatic original document feeding apparatuses have an automatic two-sided original document feeding function of automatically reading the two sides of an input original document. A method for automatically feed two-sided documents includes two modes, that is a normal-order reading mode and a batch reading mode which will be described below.

When reading an original document in the normal-order reading mode, first, the reading unit reads the front side of the original document. Next, after reversing the original document, the reading unit reads the back side of the original document. If a plurality of original documents is discharged in this way without change, the original documents are reversely discharged. Thus, after the back side is read, the reading unit reverses the original document, again. In this way, the reading unit can discharge the original documents with the original orientation maintained.

The automatic two-sided original document feeding apparatus automatically reads the two sides of each of the original documents without requiring time and effort of the user, thus the automatic two-sided original document feeding apparatus is a useful function. However, when the automatic two-sided original document feeding apparatus reverses an original document after the reading unit reads the front or back side of the original document, there is a time period that the reading unit cannot read any original document. Thus, it takes more time to read two-sided documents than to read one-sided original documents.

As a result, the automatic original document feeding apparatus exhibits a difference in performance between during reading of one-sided original documents and during reading of two-sided original documents. To improve the performance during reading of two-sided original documents, the reading unit can read the original documents in the batch reading mode. For example, Japanese Patent Application Laid-Open No. 2006-327728 discusses a method for reading original documents. According to the method, if an original document is small enough so that a plurality of original documents can be simultaneously read when compared with a sheet conveyance path of the automatic original document feeding apparatus, first, the reading unit continuously reads the front side of each of the original documents. Then, the reading unit continuously reads the back side of each of the original documents. Thus, the method can reduce the time when the original documents are not read during being reversed and improve the performance during reading of two-sided documents.

As described above, the above method causes the automatic two-sided document feeding apparatus to change the reading order of the two-sided original documents. Since the reading unit can read the original documents at high speed, the method can improve the performance during reading two sides of the original documents. However, the change of the reading order could delay start of post-reading processing. For example, the following case which delays post-reading processing is conceivable. That the automatic two-sided original document feeding apparatus changes the reading order of original documents and read in the order from the front side of the first original document, the front side of the second original document, the back side of the first original document, and the back side of the original document. Then an image forming apparatus prints images on the two sides of the original documents read in this order.

In this case, the front and back sides of the first original document need to be printed on the first print sheet. Thus, the image forming apparatus can print the first print sheet only after the reading unit finishes reading the back side of the first original document. In the batch reading mode, to read the back side of the first original document, first, the reading unit needs to read the front sides of the first and second original documents. In other words, the reading unit needs to read a total of three sides to read the back side of the first original document. Thus, the output timing of the print sheet may be delayed. In other words, if the reading unit reads original documents in the batch reading mode, while the reading efficiency is improved, the print start timing of the copy function may be delayed, counted as a problem.

### SUMMARY OF THE INVENTION

According to an aspect of the present invention, an image reading apparatus includes a reading unit configured to read a first side of an original document to be conveyed, reverse the original document, and read an image on a second side of the original document, and a control unit configured to control the reading unit to read the original document by either a first reading method or a second reading method, wherein, in the first reading method, after reading a first side of an original document to be conveyed, the reading unit reads a second side of the original document, and in the second reading method, after reading a first side of a first original document to be conveyed and a first side of a second original document subsequent to the first original document, the reading unit reads a second side of the first original document, and wherein, in a case where a plurality of original documents are conveyed, the control unit controls the reading unit to read the first original document by the first reading method and to read the second and the subsequent original documents by the second reading method.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an image processing apparatus including an image reading apparatus.

FIG. 2 is cross sections illustrating an original document reading operation executed by a reading unit in FIG. 1.

FIG. 3 is a cross section illustrating the original document reading operation executed by the reading unit in FIG. 1.

FIG. 4 is cross sections illustrating conveyance paths and conveyance statuses of original documents in the image reading apparatus.

FIG. 5 illustrates reading modes of the image reading apparatus.

FIG. 6 is cross sections illustrating conveyance statuses of original documents in the image reading apparatus.

FIG. 7 is a flow chart illustrating a control procedure of the image reading apparatus.

FIG. 8 is a flow chart illustrating a control procedure of the image reading apparatus.

FIG. 9 is a flow chart illustrating a control procedure of the image reading apparatus.

### DESCRIPTION OF THE EMBODIMENTS

Various exemplary embodiments, features, and aspects of the invention will be described in detail below with reference to the drawings.

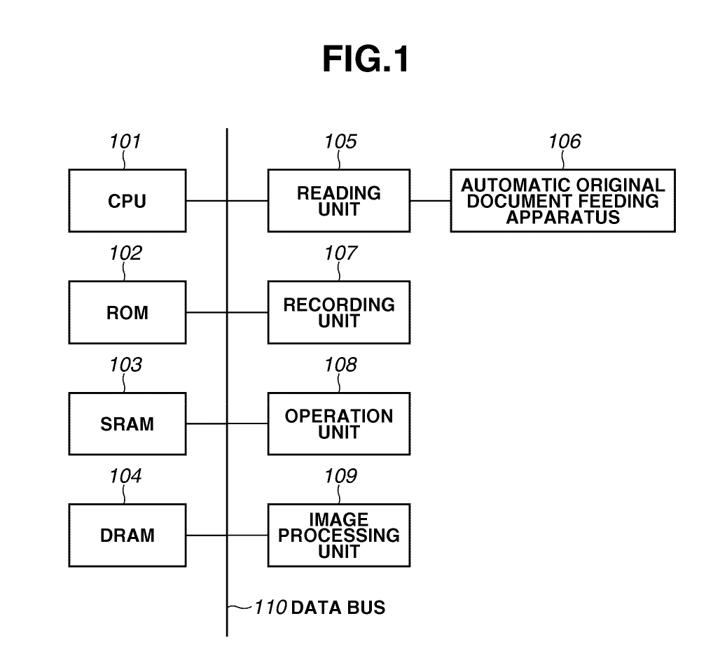

FIG. 1 is a block diagram illustrating a configuration of an image processing apparatus including an image reading apparatus according to a first exemplary embodiment. The first exemplary embodiment will be described based on an image processing apparatus capable of executing multifunction peripheral function processes such as a copy function process. However, the first exemplary embodiment is also applicable to a system in which an original document reading apparatus and a recording apparatus are independently arranged. In addition, in the present exemplary embodiment, the image reading apparatus is configured to be capable of conveying an original document to the reading unit, reversing the original document along a reversing conveyance path, and conveying the original document to the reading unit, again.

In FIG. 1, a central processing unit (CPU) 101 is a system control unit comprehensively controlling components connected to a data bus 110. A read-only memory (ROM) 102 stores control programs executed by the CPU 101. A static random access memory (SRAM) 103 stores setting values registered by an operator, apparatus management data, various work buffers, and the like.

A dynamic random access memory (DRAM) 104 stores, for example, program control variables (parameters) used when the CPU 101 executes programs. A reading unit 105 reads image data from an original document and converts the data into binary data. The reading unit 105 reads one side of the original document being conveyed. The image reading apparatus allows the original document to pass through the reading unit twice using the reversing path, so that the reading unit 105 can read the front and back sides of the original document.

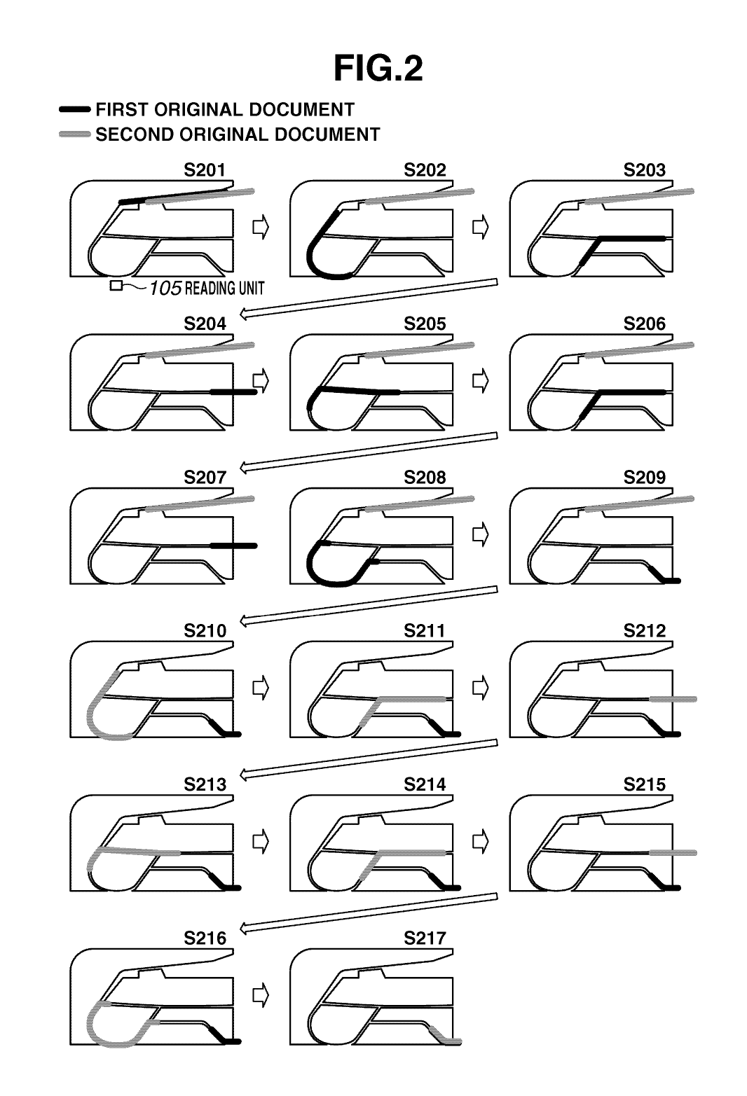

The reading unit 105 includes an automatic original document feeding apparatus 106 automatically feeding the original document to the reading unit 105. In addition, the reading unit 105 reverses the original document along the conveyance path in the automatic original document feeding apparatus 106 and reads the front and back sides of the original document at a predetermined position. The predetermined position corresponds to the installation position of the reading unit 105 illustrated in FIG. 2. More specifically, if the image processing apparatus includes the reading unit 105, the predetermined position corresponds to a position set in a feeding-reading mode. The feeding-reading mode is a mode in which the reading unit 105 is stopped at the predetermined position and reads an image corresponding to a side of the original document set on the original document positioning glass plate. The CPU 101 can change the conveyance speed of the original document based on reading conditions or print conditions.

A recording unit 107 outputs image data on a recording sheet. The recording unit 107 can print a monochrome image and/or a color image on one side and/or two sides of a fed sheet, based on the reading function of the reading unit 105.

An operation unit 108 is a user interface unit displaying device information. The operation unit 108 displays a user interface (not illustrated) on an operation screen, when the user sets the print conditions or a size of the original document to be read by the reading unit 105. The operation unit 108 receives the print conditions or the size of the original document set by the user on the displayed operation screen and notifies the CPU 101 of the information.

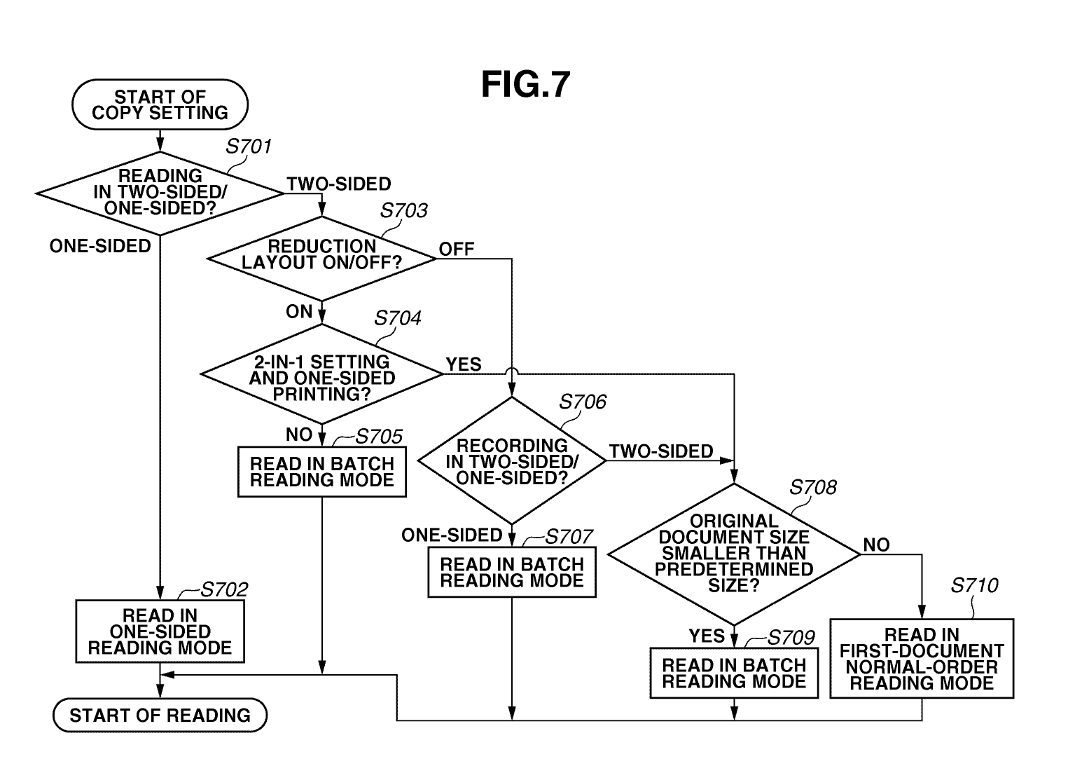

The print conditions include print layout conditions, such as reduction layout conditions (2-in-1 setting), and print conditions indicating whether the recording unit 107 needs to execute one-sided printing or two-sided printing. The CPU 101 determines whether the original document size set via the operation unit 108 is smaller than a predetermined size and controls switching of the reading modes in accordance with the procedure illustrated in FIG. 7.

The reading modes include first to third reading modes. In the first reading mode, the reading unit 105 reads the front side of an original document to be conveyed. Next, after reversing the original document, the reading unit 105 reads the back side of the original document. In the second reading mode, the reading unit 105 continuously reads the front side of each of two original documents to be conveyed. Next, after reversing the two original documents, the reading unit 105 continuously reads the back side of each of the original documents.

The third reading mode is also used when the reading unit 105 continuously reads a plurality of original documents to be conveyed. However, in the third reading mode, the reading unit 105 reads the first original document in the first reading mode and reads the subsequent original documents in the second reading mode. In the present exemplary embodiment, the first, the second, and the third reading modes respectively correspond to a normal-order reading mode, a batch reading mode, and a first-document normal-order reading mode. The latter mode names will be used in the following description.

An image processing unit 109 encodes and decodes image data used by the copy function. The image processing unit 109 includes a unit executing variable magnification processing on copied images. The individual components are connected to each other via the data bus 110, and image data is transferred through the data bus 110.

The present exemplary embodiment will be described based on such copying machine. With this copying machine, after the user places original documents on the document positioning plate, the automatic original document feeding apparatus 106 conveys the original document to the reading unit, the SRAM 103 temporarily stores the read image data, and the recording unit 107 prints the image data.

Based on the above image reading apparatus, the user can execute copy settings by operating the operation unit 108. For example, the copy settings includes setting for two-sided reading, and if the user sets the two-sided reading, the automatic original document feeding apparatus 106 automatically reverses the original document, so that the reading unit 105 can read both the front and back sides of the original document.

FIG. 2 is cross sections illustrating an original document reading operation executed by the reading unit 105 in FIG. 1. FIG. 2 illustrates the statuses of original documents conveyed along a conveyance path. For example, two original documents can be simultaneously conveyed along the conveyance path. Next, based on the automatic original document feeding apparatus 106, an operation of reading two sides of each of the two original documents will be described. First, the original document reading operation in the normal-order reading mode will be described.

First, in step S201, the user stacks two original documents on the automatic original document feeding apparatus 106, with the front side up. Next, the user operates the operation unit 108 to input an instruction to start two-sided reading. The CPU 101 drives original document conveyance rollers (not illustrated) to convey the first original document to the reading unit 105. In step S202, since the first original document passes through the reading unit 105 with the front side thereof down, the reading unit 105 can scan the front side of the first original document. After the reading unit 105 reads the front side of the first original document, the CPU 101 reverse the first original document so that the reading unit 105 can read the back side of the first original document. Therefore, in steps S203 and S204, the CPU 101 further conveys the first original document and prepares for reversal.

Next, in step S205, the CPU 101 conveys the reversed original document to the reading unit 105 again, so that the reading unit 105 can scan the back side of the first original document. At that time, the first original document is conveyed with the back side thereof up and the trailing edge thereof at the front. The first original document is conveyed along the conveyance path, and passes through the reading unit 105 again with the back side down. In this way, in step S206, the reading unit 105 can scan the back side of the first original document.

While the reading unit 105 has finished reading the front and back sides of the first original document, the CPU 101 reverses the first original document, again. This is because, if the first and second original documents are discharged in this way without change, these original documents will be discharged reversely compared to the original documents stacked on the document positioning plate.

Thus, in step S207, the CPU 101 further conveys the first original document and prepares for reversal, again. Next, in step S208, the first original document, the two sides of which have already been read, is reversed along the same conveyance path, again. Finally, in step S209, the first original document is discharged along a discharging path.

When the reading unit 105 completes reading the front and back sides of the first original document, then in step S210, the CPU 101 causes the reading unit 105 to read the second original document in the similar procedure. In steps S210 to S217, the reading unit 105 reads the two sides of the second original document. Since the operation is the same as that used to read the first original document, repetitive description thereof will be omitted.

As described above, when the automatic original document feeding apparatus 106 executes two-sided reading in the normal-order reading mode, the image processing apparatus scans the front side of an original document, reverses the original document, scans the back side of the original document, reverses the original document again, and discharges the original document. Further, when the automatic original document feeding apparatus 106 executes two-sided reading in the normal-order reading mode, there are periods when the reading unit 105 does not operate. As a result, the efficiency during two-sided reading is decreased.

In contrast, during one-sided reading, since the automatic original document feeding apparatus 106 can continuously convey original documents, the reading unit 105 can operate continuously. This is because, while the reading unit 105 is scanning an original document, the automatic original document feeding apparatus 106 can previously convey the next original document immediately before the reading unit 105. Thus, the reading unit 105 can scan the original documents at shorter intervals.

However, during two-sided reading, after scanning the front side of an original document, the reading unit 105 needs to read the backside of the same original document. Thus, the automatic original document feeding apparatus 106 cannot previously convey the next original document to be read immediately before the reading unit 105. Thus, the image processing apparatus takes a certain length of time between when the reading unit 105 reads the front side and when the reading unit 105 reads the back side (steps S203 to S205), the performance during two-sided reading is lower than that during one-sided reading.

Further, in the normal-order reading mode, during the period from when the reading unit 105 finishes reading the back side to when the original document is reversed again (steps S206 to S208), since the first original document uses the same conveyance path used by the second original document, the reading unit 105 cannot read the second original document during the reversal. In this aspect, too, the performance during two-sided reading is lower than that during one-sided reading.

Next, an automatic original document feeding apparatus capable of reading two sides of documents in the batch reading mode, instead of such two-sided reading in the normal-order reading mode, will be described. In the batch reading mode, the reading order is changed to improve reading efficiency.

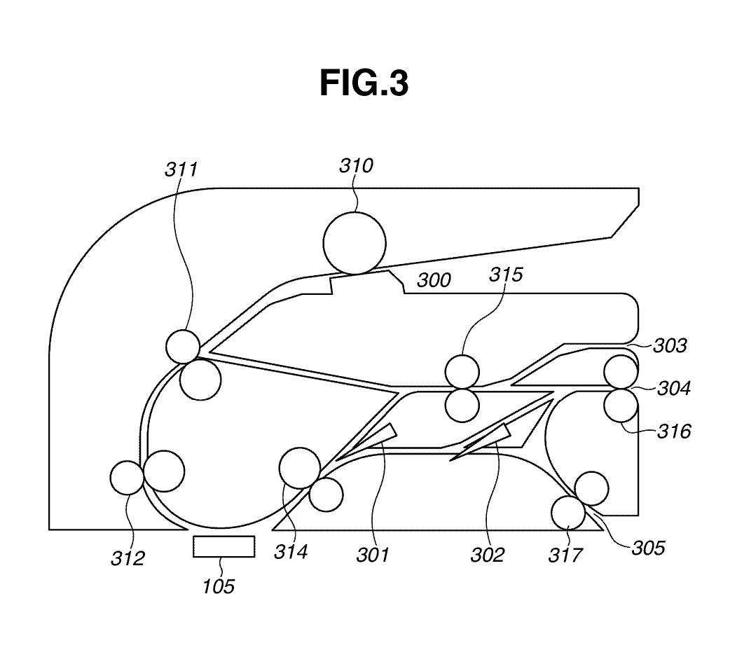

FIG. 3 is a cross section illustrating the original document reading operation executed by the reading unit 105 in FIG. 1. FIG. 3 illustrates the statuses of original documents conveyed along the conveyance path. For example, two original documents can be simultaneously conveyed along the conveyance path. In addition, the automatic original document feeding apparatus illustrated in FIG. 3 includes two sheet conveyance paths and uses diverters 301 and 302 to switch the conveyance paths.

A first conveyance path will be described below. After the user places original documents on a document positioning plate 300, the CPU 101 drives rollers 310 to 312 to convey the original document. As the original document passes through the reading unit 105, the reading unit 105 reads an image thereon. Next, the CPU 101 drives rollers 314 and turns the diverter 301 downward, to convey the original document from the rollers 314 along an upper conveyance path. The CPU 101 drives rollers 315 and causes the original document to temporarily retract in an upper reversal exit 303.

After reversing the original document, the CPU 101 drives the rollers 315, 311, and 312 to convey the original document. As the original document passes through the reading unit 105, the reading unit 105 reads the back side thereof. Then, the CPU 101 turns the diverters 301 and 302 upward, to convey the original document along a lower conveyance path. The CPU 101 drives rollers 317 and causes the original document to retract in a lower re-reversal exit 305. Finally, the CPU 101 drives the rollers 317 and 316 to discharge the original document through a lower reversal exit 304.

Next, a second conveyance path will be described. When the user places original documents on the document positioning plate 300, the CPU 101 drives the rollers 310 to 312 to convey the original document. As the original document passes through the reading unit 105, the reading unit 105 reads the original document. Next, the CPU 101 drives the roller 314 and turns the diverters 301 and 302 upward and downward respectively, to convey the original document along the lower conveyance path. In addition, the CPU 101 drives the rollers 316 and causes the original document to temporarily retract in the lower reversal exit 304.

After reversing the original document, the CPU 101 drives the rollers 315, 311, and 312 to convey the original document. As the original document passes through the reading unit 105, the reading unit 105 reads the back side thereof. The CPU 101 turns the diverters 301 and 302 upward and conveys the original document along the lower conveyance path. Then, the CPU 101 drives the rollers 317 and causes the original document to retract in the lower re-reversal exist 305. Finally, the CPU 101 drives the rollers 317 and 316 to discharge the original document through the lower reversal exit 304.

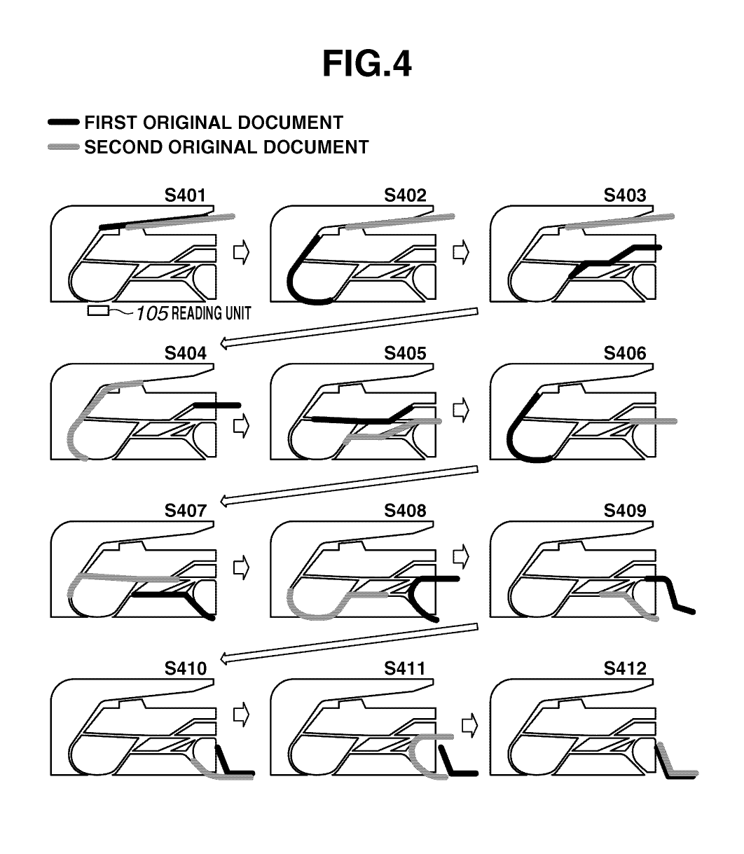

The two-sided reading operation executed by such highly-efficient automatic original document feeding apparatus illustrated in FIG. 3 will be described in detail with reference to FIG. 4.

FIG. 4 is cross sections illustrating the conveyance paths and conveyance statuses of original documents in the image reading apparatus according to the present exemplary embodiment. In FIG. 4, illustration of the diverters and the like are omitted. Hereinbelow, an example of an operation of reading two sides of each of two original documents in the batch reading mode by the automatic original document feeding apparatus will be described.

First, in step S401, the user stacks two original documents on the automatic original document feeding apparatus 106, with the front side up. Next, the user operates the operation unit 108 to input an instruction to start two-sided reading. Then, the CPU 101 drives the above-described rollers to convey the first original document. In step S402, the first original document passes through the reading unit 105, with the front side down. In this way, the reading unit 105 scans and reads the front side of the first original document.

Next, the CPU 101 reverses the first original document to read the back side thereof. Therefore, in step S403, the CPU 101 temporarily conveys the first original document further and prepares for the reversal. In addition, in step S403, the CPU 101 controls the conveyance unit to convey the first original document along the upper conveyance path. At this point, the CPU 101 starts conveying the second original document to read the front side of the second original document.

Next, in step S404, while further conveying the first original document, the CPU 101 causes the reading unit 105 to scan the front side of the second original document. Next, in step S405, the CPU 101 conveys the reversed first original document to the reading unit 105 again, to scan the back side of the first original document. Simultaneously, the CPU 101 further conveys and reverses the second original document to read the back side thereof.

In step S405, the CPU 101 controls the second original document to travel along the lower conveyance path. At that time, the first original document travels with the back side up and the trailing edge at the front. In step S406, the first original document continues to travel along the conveyance path and passes through the reading unit 105 again, with the back side down. In this way, the reading unit 105 scans the back side of the first original document. At that time, the CPU 101 further conveys and reverses the second original document.

Since the reading unit finished reading the front and back sides of the first original document, the CPU 101 reverses the first original document, again. More specifically, in step S407, after causing the first original document to pass through the reading unit 105, the CPU 101 conveys the first original document along the lowest conveyance path and reverses the first original document, again. In addition, in step S407, the CPU 101 simultaneously conveys the second original document with the back side up and the trailing edge at the front. Subsequently, the reading unit 105 starts reading the back side of the second original document. The first original document is reversed along the re-reversal conveyance path.

Simultaneously, in step S408, the reading unit 105 scans the back side of the second original document. In step S409, after reversing the first original document, the CPU 101 starts a discharge operation of the first original document and conveys the second original document along the re-reversal conveyance path to reverse the second original document. In steps S410 to S412, the CPU 101 discharges the first original document from the automatic original document feeding apparatus 106 and reverses and discharges the second original document.

The image reading apparatus according to the present exemplary embodiment can realize high reading efficiency by reading the second original document while reversing the first original document.

According to the image reading apparatus illustrated in FIG. 3, the CPU 101 controls reading of the original documents in the following order: the front side of the first original document, the back side of the first original document, the front side of the second original document, the back side of the second original document, the front side of the third original document, the back side of the third original document, and so on.

However, according to the image reading apparatus illustrated in FIG. 4, the CPU 101 controls reading of the original documents in the following order: the front side of the first original document, the front side of the second original document, the back side of the first original document, the back side of the second original document, the front side of the third original document, the front side of the fourth original document, and so on.

Next, the operations when the two-sided printing function is executed by the image reading apparatus illustrated in FIG. 3 and that in FIG. 4 will be compared.

For example, if two-sided printing is executed on a two-sided document, the two sides of the output print product have been printed. In other words, the first print product has to have images on the front and back sides of the first original document. Thus, the image reading apparatus cannot print the first print product unless the image reading apparatus acquires image data pieces on the front and back sides of the first original document.

In the case of the image reading apparatus illustrated in FIG. 3, when finishing reading both the front and back sides of the first original document, the image reading apparatus can acquire data necessary to print the first print product. Thus, at this point, the image reading apparatus can be ready to print the first print product.

In contrast, the image reading apparatus illustrated in FIG. 4 cannot acquire image data necessary to print the first print product, unless the image reading apparatus finishes reading the three sides, that is, the front side of the first original document, the front side of the second original document, and the back side of the first original document.

Thus, the image reading apparatus illustrated in FIG. 4 requires more time to output the first print product than the image reading apparatus illustrated in FIG. 3.

The faster the image processing apparatus can output the first print product, the higher operational responsiveness to the user is. Thus, this printing speed is an important performance value. As described above, when executing two-sided printing, the image reading apparatus illustrated in FIG. 4 requires more time to print the first print product than the image reading apparatus illustrated in FIG. 3. As a result, users find the image reading apparatus illustrated in FIG. 4 undesirable during two-sided printing.

To solve this problem, in the present exemplary embodiment, based on the image reading apparatus having the conveyance paths and conveyance control illustrated in FIG. 4, the CPU 101 controls image reading by combining benefits in the normal-order reading mode and the batch reading mode. In other words, the image reading apparatus according to the present exemplary embodiment has a plurality of reading modes each having a different original document reading order.

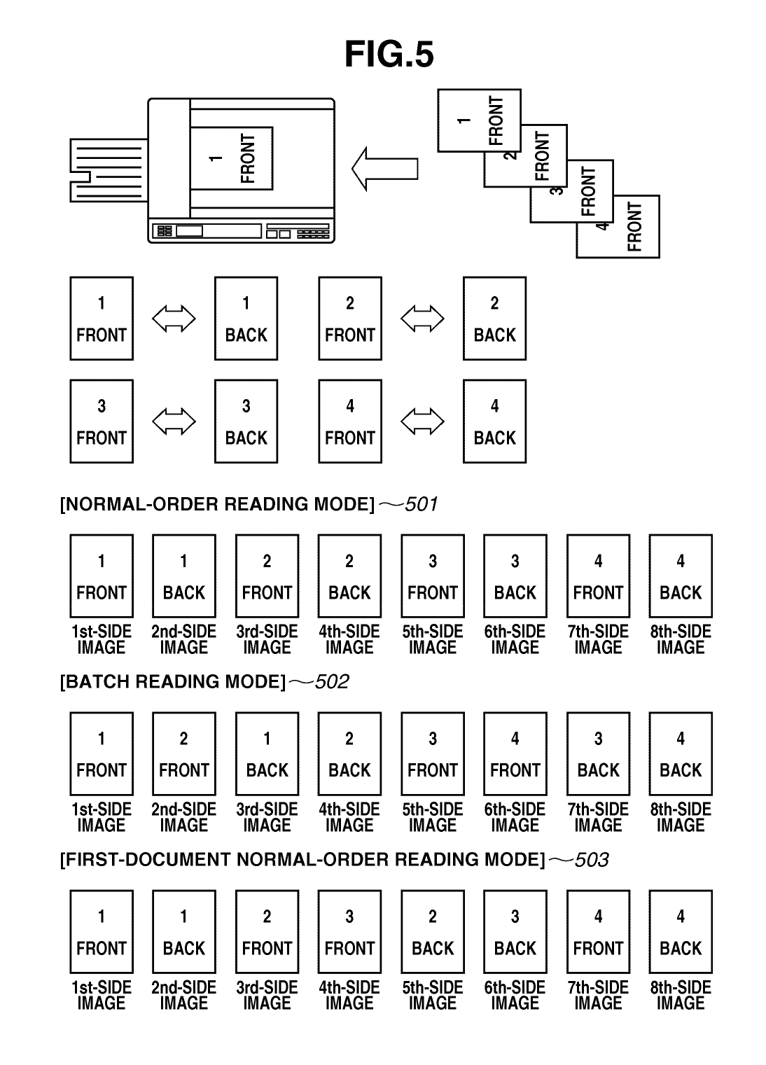

FIG. 5 illustrates reading modes of the image reading apparatus according to the present exemplary embodiment. FIG. 5 illustrates examples when the user stacks four original documents on the document reading apparatus to execute two-sided reading.

Hereinbelow, the order of reading a stack of four two-sided documents with the front side up will be described.

First, the reading order, which will be referred to as a normal-order reading mode 501, used by the image reading apparatus illustrated in FIG. 3 will be described. In the normal-order reading mode 501, the image reading apparatus conveys, reverses, and reads the original documents one by one as illustrated in FIG. 5. Thus, the image reading apparatus reads the original documents in the following order: the front side of the first original document, the backside of the first original document, the front side of the second original document, the back side of the second original document, the front side of the third original document, the back side of the third original document, the front side of the fourth original document, and the back side of the fourth original document.

Next, the reading order, which will be referred to as a batch reading mode 502, used by the image reading apparatus as illustrated in FIG. 4 will be described. In the batch reading mode 502, since the image reading apparatus reads the second original document during reversal of the first original document, the reading efficiency can be improved. In the example in FIG. 5, the image reading apparatus reads the original documents in the batch reading mode 502 on a two-original-document basis. In the batch reading mode 502 on the two-original-document basis, while reversing one original document, the image reading apparatus reads the other original document. Thus, as illustrated in FIG. 5, the image reading apparatus reads the original documents in the following order: the front side of the first original document, the front side of the second original document, the back side of the first original document, the back side of the second original document, the front side of the third original document, the front side of the fourth original document, the back side of the third original document, and the back side of the fourth original document.

In addition, if the image reading apparatus illustrated in FIG. 4 reads two-sided documents in the batch reading mode, printing of the first original document is delayed. Thus, to avoid this delay, in the present exemplary embodiment, the image reading apparatus includes another reading mode. This mode will be referred to as a first-document normal-order reading mode 503.

FIG. 5 illustrates the first-document normal-order reading mode 503 for reading the original documents on a two-original-document basis. In the first-document normal-order reading mode 503, the image reading apparatus first reads the front and back sides of the first original document. The image reading apparatus reads the subsequent original documents in the batch reading mode. Thus, in the first-document normal-order reading mode 503 on the two-original-document basis, the image reading apparatus reads the original documents in the following order: the front side of the first original document, the back side of the first original document, the front side of the second original document, the front side of the third original document, the backside of the second original document, the back side of the third original document, the front side of the fourth original document, and the back side of the fourth original document.

In this way, in the present exemplary embodiment, the image reading apparatus has a plurality of reading modes and appropriately switches the batch reading mode 502 and the first-document normal-order reading mode 503. Thus, the image reading apparatus can realize optimum print performance.

The image reading apparatus requires less time to read all the four two-sided original documents in the batch reading mode 502 on the two-original-document basis than in the first-document normal-order reading mode 503 on the two-original-document basis. However, if the user specifies a certain copy setting such as two-sided reading and two-sided printing, the output timing of the first print product by the recording unit 107 is delayed.

Next, copy settings that delay the output timing of the first print product by the recording unit 107 in the batch reading mode will be described.

There are cases where the image reading apparatus can quickly print the first print product as soon as image data pieces of the front and back sides of the first original document are acquired. In such cases, if the image reading apparatus uses the batch reading mode, the output timing of the first print product may be delayed. In contrast, for example, in the case of two-sided reading and one-sided printing in which the image reading apparatus can output the first print product after reading an image on one side of an original document, even if the image reading apparatus uses the batch reading mode from the beginning, instead of the first-document normal-order reading mode, the output timing of the first print product is not delayed.

In addition, as in 4-UP printing, if the image reading apparatus cannot execute printing unless the four sides, that is, the front and back sides of the first and second original documents are acquired, even if the image reading apparatus reads the documents in the batch reading mode from the beginning, the output timing of the first print product is not delayed.

In other words, during reading of two original documents in the batch reading mode, if the image reading apparatus can print the first print product as soon as the image reading apparatus acquires image data of the front and back sides of the first original document, the image reading apparatus may read the original documents in the first-document normal-order reading mode. In this way, a delay of the output timing of the first print product is appropriately prevented. More specifically, the first-document normal-order reading mode can be used when the user sets the copy setting for two-sided reading and two-sided printing of 1-UP printing, or the copy setting for two-sided reading and one-sided printing of 2-UP printing.

As described above, if the image reading apparatus can print the first print product as soon as image data pieces of the front and back sides are acquired, by reading the original documents in the first-document normal-order reading mode, a delay of the output timing of the first print product can be prevented. However, even under the above-described conditions, there are cases where the output timing of the first print product does not change. More specifically, the output timing of the first print product may be delayed depending on the size of the original documents.

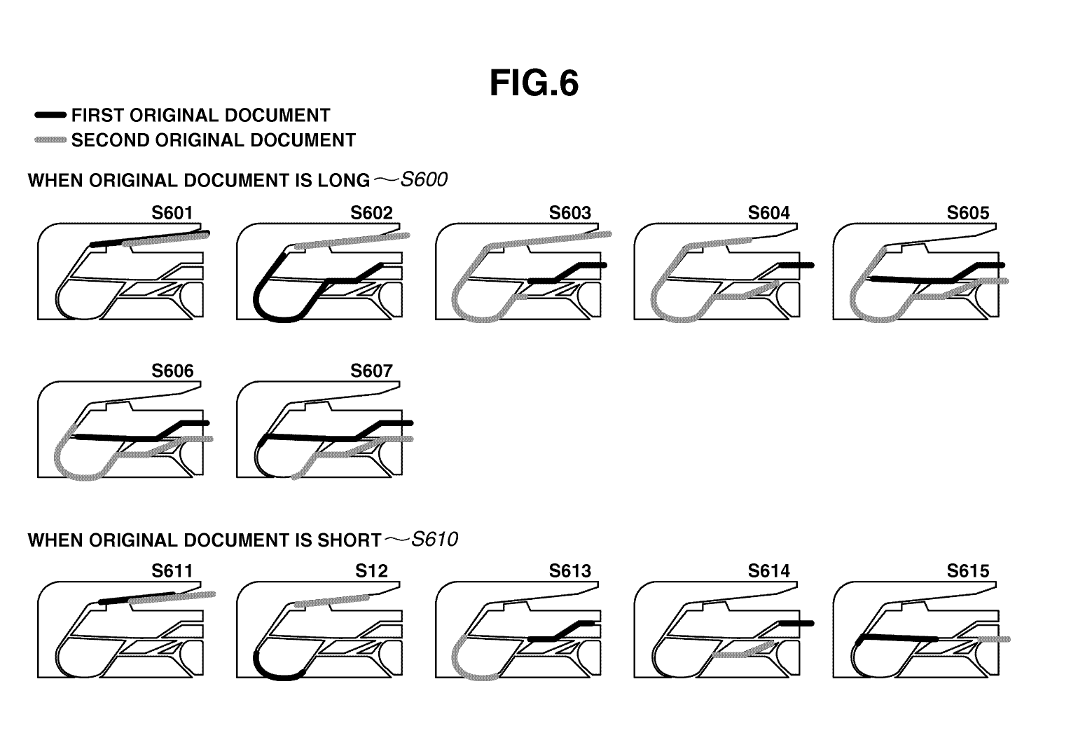

FIG. 6 is cross sections illustrating conveyance statuses of original documents in the image reading apparatus according to the present exemplary embodiment. The image reading apparatus has the same conveyance path configuration as that illustrated in FIG. 4. The image reading apparatus illustrated in FIG. 4 reads the second original document while reversing the first original document to improve reading efficiency.

Steps S601 to S607 in FIG. 6 illustrate an operation of reading original documents in the batch reading mode 502, the original documents having a length in the conveyance direction greater than a predetermined length. First, the image reading apparatus reads the front side of the first original document and reverses the first original document to read the back side thereof. However, at this point, since the image reading apparatus is reading the second original document, the image reading apparatus cannot convey the first original document to the reading position. As a result, as illustrated in steps S605 and S606, the first original document needs to wait for a predetermined time. Since the first original document needs to wait in this way, when the image reading apparatus reads original documents having a length in the conveyance direction greater than the predetermined length in the batch reading mode, the image reading apparatus cannot realize the same reading performance as in a one-sided reading mode. Thus, if the original documents have a length greater than the predetermined length, by reading the original documents in the first-document normal-order reading mode, the image reading apparatus can prevent a delay in the output timing of the first print product.

In contrast, steps S611 to S615 in FIG. 6 illustrate an operation of reading original documents in the batch reading mode, the original documents having a length in the conveyance direction less than or equal to the predetermined length. First, the image reading apparatus reads the front side of the first original document, reverses the first original document, and reads the back side thereof. In this case, since the original documents are short, while reading and reversing the front side of the first original document, the image reading apparatus can complete reading the front side of the second original document. Thus, the first original document does not need to wait between being reversed and read the back side thereof. In such case, if the image reading apparatus reads the original documents either in the batch reading mode or in the first-document normal-order reading mode, the output timing of the first print product is not changed.

Overall, the image reading apparatus requires more time to read original documents in the first-document normal-order reading mode than in the batch reading mode. Thus, if the output timing of the first print product is the same, it is desirable to use the batch reading mode.

Reading control for appropriately switching a reading mode according to the copy function setting will be described in detail below, based on the image reading apparatus having a configuration illustrated in FIG. 4 and two reading modes, that is, the batch reading mode and the first-document normal-order reading mode.

FIG. 7 is a flow chart illustrating a control procedure executed by the image reading apparatus according to the present exemplary embodiment. In this process, the image reading apparatus determines a reading mode based on a relationship between a type of an original document to be read and the print mode of the recording unit. The CPU 101 realizes each of the steps by executing a control program read from the ROM 102. In the following, an operation of switching to the first-document normal-order reading mode will be described in which the CPU 101 causes the reading unit to read the first original document in the normal-order reading mode and to read the subsequent original documents in the batch reading mode. In the present exemplary embodiment, even if the reading unit 105 reads images on the two sides of each of a plurality of original documents and the recording unit 107 prints the images continuously, the image reading apparatus can prevent a delay of the print starting timing of the first print product. The user operates the operation unit 108 to input copy settings and start a copy job.

First, in step S701, the CPU 101 determines whether a copy job setting set by the user via the operation unit 108 indicates two-sided reading. If the CPU 101 determines that one-sided reading is set (ONE-SIDED in step S701), the CPU 101 determines that there is no need to change the reading control, and the operation proceeds to step S702. Accordingly, in step S702, the CPU 101 determines to set a conventional one-sided reading mode as the original document reading mode and starts reading the original documents in the one-sided reading mode.

Whereas, in step S701, if the CPU 101 determines that two-sided reading is set as the reading mode (TWO-SIDED instep S701), the operation proceeds to step S703. In the following steps, the CPU 101 determines what print modes have been set as other copy setting items.

First, in step S703, the CPU 101 determines whether the user has set a reduction layout setting ON as a print mode input via the operation unit 108. If the CPU 101 determines that the reduction layout setting is ON (ON in step S703), then in step S704, the CPU 101 determines contents of the reduction layout setting. More specifically, in step S704, the CPU 101 determines whether the reduction layout setting set by the user via the operation unit 108 indicates a 2-in-1 setting and one-sided printing.

If the CPU 101 determines that the 2-in-1 setting and one-sided printing are set (YES in step S704), the CPU 101 determines that the settings correspond a condition where the image reading apparatus can print the first print product as soon as the front and back sides of the first original document are read. Thus, in this case, the printing speed may be increased by reading the original document in the first-document normal-order reading mode. However, if another reduction layout setting is set, even if the image reading apparatus reads the original document in the first-document normal-order reading mode 503, the output timing of the first print product cannot be improved. Thus, if the CPU 101 determines that the reduction layout setting and the 2-in-1 setting are set but one-sided printing is not set (NO in step S704), the operation proceeds to step S705. In step S705, the CPU 101 reads the original documents in the batch reading mode.

In step S703, if the CPU 101 determines that the reduction layout setting as the copy setting is OFF (OFF in step S703), the operation proceeds to step S706. In step S706, the CPU 101 checks a recording setting and determines which is set, one-sided printing or two-sided printing. If the CPU 101 determines that two-sided printing is set (TWO-SIDED in step S706), the CPU 101 determines that the settings correspond a condition where the image reading apparatus can print the first print product as soon as the front and back sides of the first original document are read. Thus, in this case, the printing speed may be increased by reading the original documents in the first-document normal-order reading mode.

However, if one-sided printing is set, even if the image reading apparatus reads the original documents in the first-document normal-order reading mode 503, the output timing of the first print product cannot be advanced. Thus, if the CPU 101 determines that two-sided printing is not set (ONE-SIDED in step S706), the operation proceeds to step S707. In step S707, the CPU 101 determines that the batch reading mode 502 is appropriate as the reading mode and starts reading the documents in the batch reading mode 502.

In step S704, if the CPU 101 determines that the set print mode indicates the reduction layout setting ON, the 2-in-1 printing, and one-sided printing (YES in S704), the operation proceeds to step S708. If the CPU 101 determines that the reduction layout setting is OFF in step S703 and two-sided printing is set in step S706, the output timing of the first print product may be advanced by reading the original documents in the first-document normal-order reading mode.

Next, in step S708, the CPU 101 checks the size of the original documents to be read. As described with FIG. 6, if the size of the original documents is smaller than a predetermined size (if the original documents have a length in the conveyance direction shorter than a predetermined length), even if the image reading apparatus reads the original documents in the first-document normal-order reading mode, the output timing of the first print product is not advanced. Thus, in step S708, the CPU 101 checks the size of the original documents. Before start of reading the original documents, the user specifies the size of the original documents via the operation unit 108.

In step S708, if the CPU 101 determines that the original document size is smaller than the predetermined size (YES in step S708), the operation proceeds to step S709. In step S709, the CPU 101 determines that the batch reading mode is appropriate as the reading mode and starts reading the documents in the batch reading mode.

Whereas, in step S708, if the CPU 101 determines that the original document size is greater than the predetermined size (if the original documents have a length in the conveyance direction longer than the predetermined length) (NO in step S708), the operation proceeds to step S710. In step S710, the CPU 101 determines that the first-document normal-order reading mode is appropriate as the reading mode and starts reading the original documents in the first-document normal-order reading mode.

As described above, the CPU 101 can appropriately switch the reading modes based on contents of the copy setting set by the user. Thus, when the image reading apparatus according to the present exemplary embodiment, more specifically, when the image reading apparatus illustrated in FIG. 4 executes a copy process, the image reading apparatus can read original documents in an reading mode by which the optimum performance can be expected.

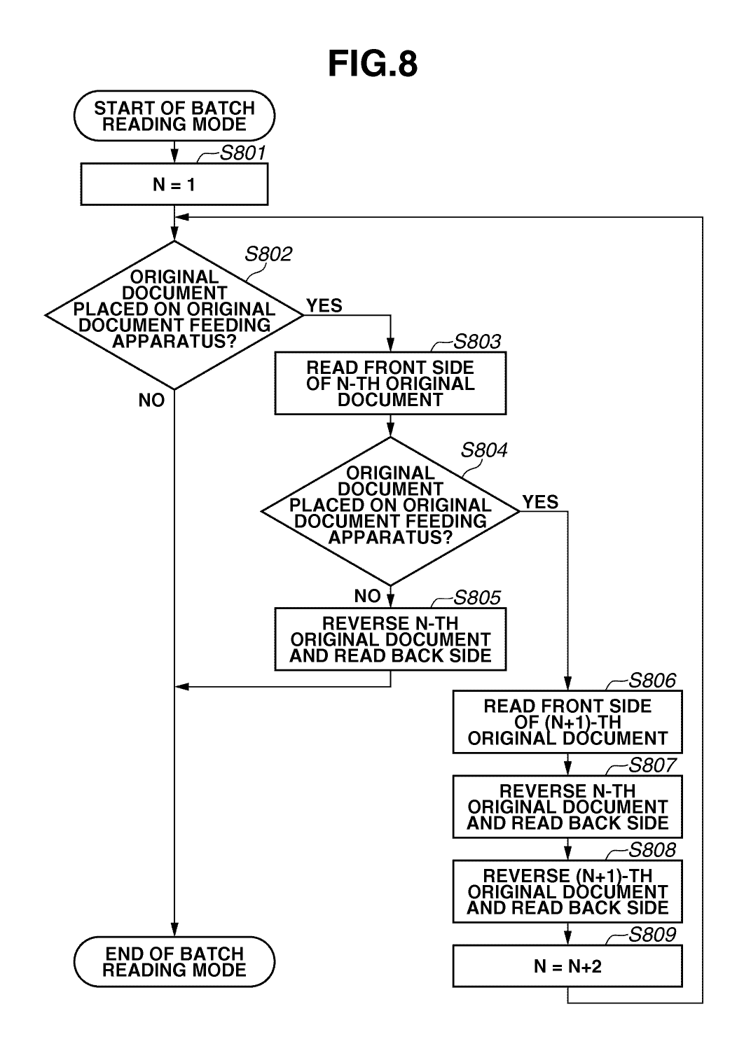

FIG. 8 is a flow chart illustrating a control procedure executed by the image reading apparatus according to the present exemplary embodiment. This process corresponds to the reading process in the batch reading mode 502 selected in steps S705, S707, and S709 in FIG. 7. The CPU 101 realizes each of the steps by executing a control program read from the ROM 102.

In the batch reading mode, first, in step S801, the CPU 101 initializes a read number counter N to “1”. Next, in step S802, the CPU 101 determines whether an original document is placed on the document positioning plate based on a detection value of a sensor (not illustrated) on the automatic original document feeding apparatus 106. If the CPU 101 determines that no original document is placed on the automatic original document feeding apparatus 106 (NO in step S802), the CPU 101 ends the process.

If the CPU 101 determines that an original document is placed on the automatic original document feeding apparatus 106 (YES in step S802), the operation proceeds to step S803. In step S803, the reading unit 105 reads the front side of the first original document.

In step S804, after the reading unit 105 reads the front side of the first original document, the CPU 101 determines whether a subsequent original document exists on the automatic original document feeding apparatus 106, based on the detection status of the sensor.

If the CPU 101 determines that no original document exists on the automatic original document feeding apparatus 106 (NO in step S804), the CPU 101 determines that the first original document, whose front side has been read, is the last original document, and the operation proceeds to step S805. In step S805, the CPU 101 immediately reverses the first original document and reads the back side thereof. Then, the CPU 101 ends the process.

In step S804, after the reading unit 105 reads the first original document, if the CPU 101 determines that a subsequent original document exists on the automatic original document feeding apparatus 106 (YES in step S804), the operation proceeds to step S806. In step S806, the reading unit 105 reads the front side of the second original document. Then, in step S807, the CPU 101 reverses the first original document along the reversing conveyance path and causes the reading unit 105 to read the back side of the first original document.

Finally, in step S808, the CPU 101 reverses the second original document along the reversing conveyance path and causes the reading unit 105 to read the back side of the second original document. In step S809, the CPU 101 increments the read number counter N by 2, and the operation returns to step S802. In step S802, the CPU 101 determines whether a subsequent original document exists, based on the detection status of the sensor. In such a manner, the CPU 101 continues the reading process until the CPU 101 processes all the original documents on the automatic original document feeding apparatus 106.

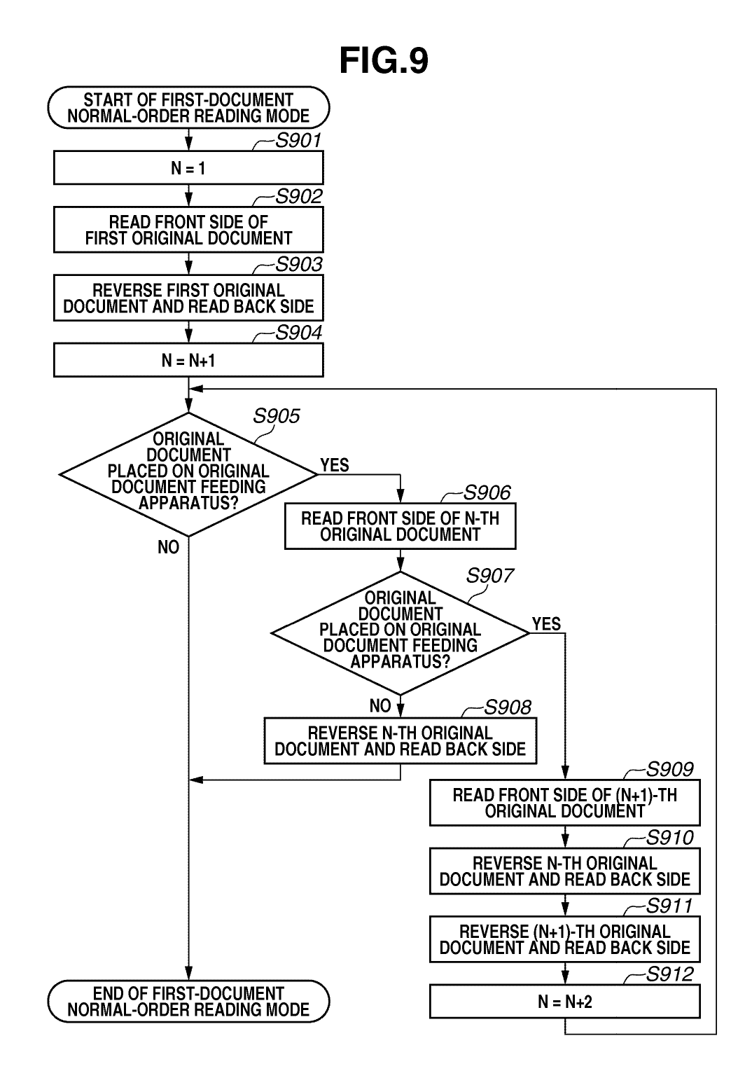

FIG. 9 is a flow chart illustrating a control procedure executed by the image reading apparatus according to the present exemplary embodiment. This process corresponds to a reading process in the first-document normal-order reading mode 503 selected in S710 illustrated in FIG. 7. The CPU 101 realizes each of the steps by executing a control program read from the ROM 102.

In the first-document normal-order reading mode, first, in step S901, the CPU 101 initializes the read number counter N to “1”. Next, the CPU 101 determines whether an original document exists on the automatic original document feeding apparatus 106, based on the detection status of the sensor. If the CPU 101 determines that an original document exists on the automatic original document feeding apparatus 106, then in step S902, the CPU 101 conveys the first original document and causes the reading unit 105 to read the front side of the first original document.

Next, in step S903, the CPU 101 reverses the first original document along the reversing conveyance path and causes the reading unit 105 to read the back side of the first original document. In the first-document normal-order reading mode, the CPU 101 will cause the reading unit 105 to read the first original document in this way.

Next, after the reading unit 105 reads the front and back sides of the first original document, in step S904, the CPU 101 increments the read number counter N by 1.

Next, in step S905, the CPU 101 determines whether an original document exists on the automatic original document feeding apparatus 106, based on the detection status of the sensor. If the CPU 101 determines that no original document is placed on the automatic original document feeding apparatus 106 (NO in step S905), the CPU 101 ends the process.

Whereas, if the CPU 101 determines that an original document exists on the automatic original document feeding apparatus 106 (YES in step S905), the operation proceeds to step S906. In step S906, the CPU 101 conveys the second original document and causes the reading unit 105 to read the front side of the second original document.

Then, in step S907, after the reading unit 105 reads the front side of the second original document, the CPU 101 determines whether a subsequent original document exists on the automatic original document feeding apparatus 106 based on the detection status of the sensor.

If the CPU 101 determines that no original document exists on the automatic original document feeding apparatus 106 (NO in step S907), the CPU 101 determines that the second original document, whose front side has been read, is the last original document. Thus, in step S908, the CPU 101 reverses the second original document along the reversing conveyance path and causes the reading unit 105 to read the back side thereof. Then, the CPU 101 ends the process.

In step S907, after the reading unit 105 reads the second original document, if the CPU 101 determines that a subsequent original document exists on the automatic original document feeding apparatus 106 (YES in step S907), the operation proceeds to step S909. In step S909, the CPU 101 conveys the third original document and causes the reading unit 105 to read the front side of the third original document.

Next, in step S910, the CPU 101 reverses the second original document along the reversing conveyance path and causes the reading unit 105 to read the back side thereof.

Finally, in step S911, the CPU 101 reverses the third original document along the reversing conveyance path and causes the reading unit 105 to read the back side thereof. In step S912, the CPU 101 increments the read number counter N by 2, and the operation returns to step S905. In step S905, the CPU 101 further determines whether a subsequent original document to be read exists based on the detection state of the sensor. In such a manner, the CPU 101 continues control of the reading process until the CPU 101 processes all the original documents on the automatic original document feeding apparatus 106.

In the present exemplary embodiment, the CPU 101 determines whether to execute processes in step S709 or S710 based on the original document size determined in step S708. However, the present invention is not limited to such example. If the operation proceeds to step S708, the CPU 101 may skip step S708 and proceeds to step S710.

Aspects of the present invention can also be realized by a computer of a system or apparatus (or devices such as a CPU or an MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium). In an example, a computer-readable storage medium may store a program that causes an image reading apparatus to perform a method described herein. In another example, a central processing unit (CPU) may be configured to control at least one unit utilized in a method or apparatus described herein.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-083689 filed Apr. 5, 2011, which is hereby incorporated by reference herein in its entirety.

What is claimed is:

1. An image reading apparatus, comprising:
a reading unit configured to read a first side of an original document to be conveyed, reverse the original document, and read an image on a second side of the original document; and
a control unit configured to control the reading unit to read the original document by either a first reading method or a second reading method,
wherein, in the first reading method, after reading a first side of an original document to be conveyed, the reading unit reads a second side of the original document, and in the second reading method, after reading a first side of a first original document to be conveyed and a first side of a second original document subsequent to the first original document, the reading unit reads a second side of the first original document, and
wherein, in a case where a plurality of original documents are conveyed, the control unit controls the reading unit to read the first original document by the first reading method and to read the second and the subsequent original documents by the second reading method.

2. The image reading apparatus according to claim 1, further comprising:
a determining unit configured to determine whether two-sided reading or one-sided reading is set,
wherein, in a case where the determining unit determines that the one-sided reading is set, the control unit controls the reading unit to read the first and the subsequent original documents by the first reading method.

3. The image reading apparatus according to claim 2, further comprising:
a judgment unit configured to judge whether a setting of printing images of two sides of an original document on a single sheet is set,
wherein, in a case where the determining unit determines that the two-sided reading is set, the judgment unit judges that the setting of printing images of two sides of an original document on a single sheet is set, and a plurality of original documents are conveyed, the control unit controls the reading unit to read the first original document by the first reading method and the second and the subsequent original documents by the second reading method.

4. The image reading apparatus according to claim 3, wherein the setting of printing images of two sides of an original document on a single sheet is a two-sided printing setting.

5. The image reading apparatus according to claim 3, wherein the setting of printing images of two sides of an original document on a single sheet is a 2-in-1 setting.

6. A method for controlling an image reading apparatus configured to read a first side of an original document to be conveyed, reverse the original document, and read an image on a second side of the original document, the method comprising:
controlling a reading of the original document by either a first reading method or a second reading method,
wherein, in the first reading method, after reading a first side of an original document to be conveyed, reading includes reading a second side of the original document, and in the second reading method, after reading a first side of a first original document to be conveyed and a first side of a second original document subsequent to the first original document, reading includes reading a second side of the first original document, and
wherein, in a case where a plurality of original documents are conveyed, controlling the reading includes reading the first original document by the first reading method and reading the second and the subsequent original documents by the second reading method.

7. A non-transitory computer readable storage medium storing a program that causes an image reading apparatus to perform the method according to claim 6.
